(19) United States
(12) Patent Application Publication
(10) Pub. No.: US 2017/0270825 A1
(43) Pub. Date: Sep. 21, 2017

(54) DEVICE AND SYSTEM FOR AIDING COMMUNICATION BY A PERSON WITH DISABILITY

(71) Applicant: Jacob Smilg, Cincinnati, OH (US)

(72) Inventor: Jacob Smilg, Cincinnati, OH (US)

(21) Appl. No.: 15/460,437

(22) Filed: Mar. 16, 2017

Related U.S. Application Data
(60) Provisional application No. 62/310,916, filed on Mar. 21, 2016.

(51) Int. Cl. G09B 21/00; H01H 13/02; H01H 13/52; H01H 13/14

(52) U.S. Cl. CPC G09B 21/00; H01H 13/14; H01H 13/023; H01H 13/52; H01H 2219/014; H01H 2219/039

(57) ABSTRACT

A system and method for enabling a person with very limited motor and verbal skills to communicate with another person. The system has a pair of spring-loaded buttons having a switch and a contact surface that is pushed by the person to send a contact signal to a controller unit to convert the contact signal into an indication signal. The indication signal is sent to an display to display a message in response to the selected movement of the person's head.

### CROSS-REFERENCE TO RELATED APPLICATION

This application claims the benefit of U.S. Provisional Application 62/310,916, filed Mar. 21, 2016, the disclosure of which is incorporated by reference in its entirety.

### FIELD OF THE INVENTION

This invention pertains to a device and a system for aiding communication by a person with a disability.

### BACKGROUND OF THE INVENTION

Some persons have a disability that prevents them from speaking, and well as a disability of motor skills to the hands and fingers that prevent the person from writing, typing, or gesturing to others in order to communicate. Often, such persons have very limited movement and motor skills to all parts of the body, including the head. Nevertheless, even very limited motor skills might he useful for this person to formulate communications with other persons, including parents, siblings other family members, best friends, other friends, caregivers and medical personnel, and others.

### SUMMARY OF THE INVENTION

The present invention provides a system and a method to enable a person with very limited motor and verbal skills to communicate with other persons. The system includes a selector device for communicating a selected movement of the body of the person as an electronic signal, a controller for converting the electronic signal into an indication signal, and an indicator device that receives the indication signal and emits a resulting message in response to the selected movement of the person's body.

In an aspect of the invention, the person is a person with limited motor control or his or her arms and legs (for example, a quadriplegic), and the selector device is configured to interface with the head of the person.

In another aspect of the invention, the selector device includes a moveable element having an interface surface, and the person moves the body portion into contact with the interface surface to move the moveable element into contact with a switch, for actuating the switch.

In a further aspect of the invention, the moveable element can be a spring-biased element. A non-limiting example of a spring-biased element is the surface of a spring-biased button having an outer surface are sufficient for easy and effective biasing contact by the head of the person. The biasing of the button results in actuating of a switch.

The selector device can include a mechanical device comprising a base member including a switch and a moveable member having a contact surface configured for biasing the moveable member relative to the base member to actuate the switch. The actuation of the switch provides an electronic communication with a controller unit. The electronic communication can include a contact signal as a result or indication that the person has moved a part of his/her body into contact with the contact surface of the moveable member in a manner sufficient to bias the moveable member relative to the base member and to actuate the switch.

In a further aspect of the invention, the switch is an electronic switch, including an electromechanical switch. The switch can include a momentary or biased switch, or a toggle switch, for closing and opening the electrical contacts of the switch. In a particular embodiment, the switch is a push-to-make switch, or a push-to-break switch.

In another aspect of the invention, the selector device also includes a means for transmitting an electronic signal from the selector device to a controller. In an aspect of the invention, the activation of the switch closes (or opens) a circuit between the selector device and the controller, which sends the electronic signal across a wired connection between the interface device and the controller. In an alternative aspect of the invention, the activation of the switch effects the transmission of a wireless signal from the selector device, by a wireless signal transmission device, that can be received by the controller by means of a wireless signal receiver.

In an aspect of the invention, a controller includes a microprocessor for analyzing the received electronic signal, and converting the electronic signal into an indication signal. The microprocessor includes memory and programming for executing an algorithm that converts the received electronic signal to an indication signal. The indication signal is an electronic signal transmitted on a conductive wire or circuit, or transmitted wirelessly, that is received by an indicator device. The indicator device receives the indication signal and emits in response a resulting message in response to the selected movement of the person's body.

In an aspect of the invention, the indicator device can comprise one or a plurality of indicator devices, which can be the same or different devices. A non-limiting examples of an indicator device can include a light-emitting device that can include a lamp or a display panel, and the resulting message is an emitted light wave. The lamp can include an incandescent, compact fluorescent, or light emitting diode (LED) illumination element. The display can include a matrix of illumination elements including mono-chromic or multicolored illumination elements. Specific though non-limiting examples of a display can include a liquid crystal display, a matrix comprising one or a plurality of monochromic LEDs, where the plurality of LEDs emit light having the same or different illumination wavelengths, or “colored lights”. The resulting message can include a lamp that emits light of a particular color; for example, a red color or a green color. The resulting message can also include an icon or a message that is illuminated from a video or light display, which emits a light of a particular color (for example, a red color or a green color), or an icon (for example, a “thumbs up”, or a “thumbs down”, or and emoji), or a text image. The resulting message can be intended to be viewed or informing to another person, thus enabling the user of the system to communicate.

### BRIEF DESCRIPTION OF THE FIGURES

FIG. 1 shows a controller device for use with a system by a person with very limited motor skills to communicate.

FIG. 2 illustrates the controller device and the system of the invention in use by a person with very limited motor skills to communicate.

FIG. 3 shows a schematic of the device of FIG. 2 and its components including controller and a display.

FIG. 4 shows push-button mechanism for the user to actuate a switch.

FIG. 5 shows an embodiment of the display that includes a plurality of light elements, and a pattern of illumination in a ready state.

FIG. 6 shows the display of FIG. 5 with pattern of illumination in a first response state.

FIG. 7 shows the display of FIG. 5 with pattern of illumination in a second response state.

FIG. 8 illustrates another device of the invention in use by the person to communicate.

FIG. 9 shows a schematic of the device of FIG. 8 and its components including a controller and a pair of indicators.

FIG. 10 shows a mechanism having a switch and a moveable member for the user to actuate the switch.

FIG. 11 shows the mechanism of FIG. 10 after the user has actuated the switch.

### DETAILED DESCRIPTION OF THE INVENTION

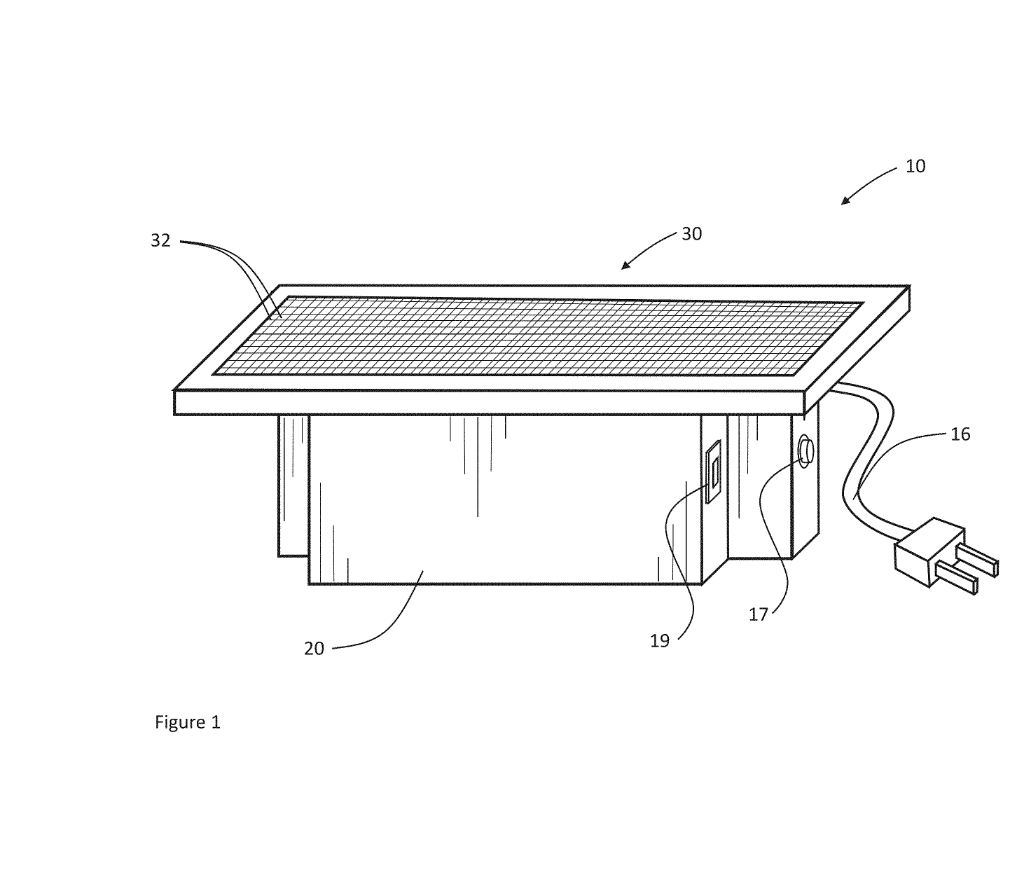

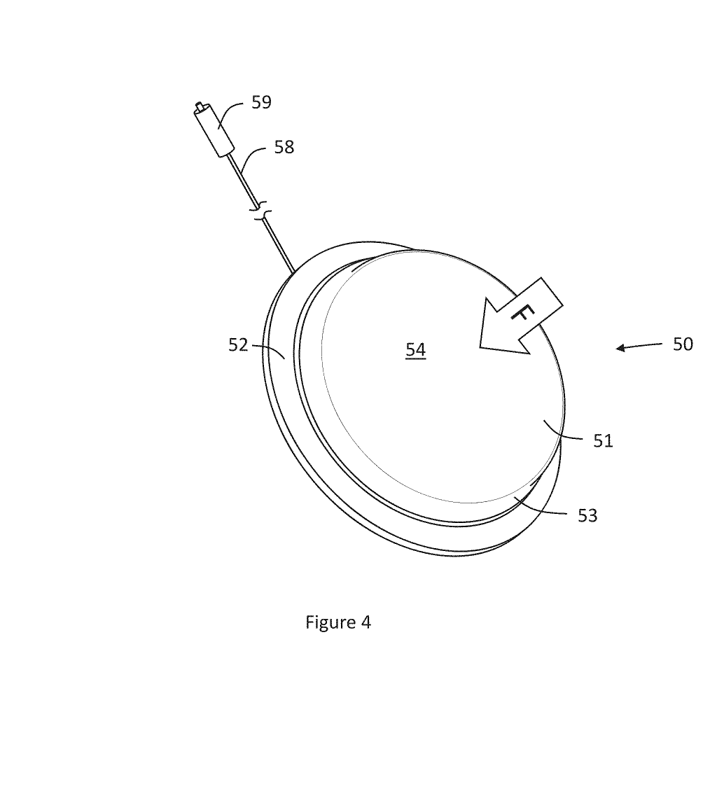

An embodiment of the invention is shown in FIGS. 1-4. A system 1 in use by a person P having very limited motor skills, for communicating with other persons. The system 1 includes a controller 10, a display 30, and a pair of selector devices 50. The selector device 50 includes a body 52, an interface surface 54, a switch 56, and a wired connection 58 communicating between the selector device 50 and the controller 10. The selector device 50 is illustrated as a push-button switch device 51 having a dual wire cable 57 connected to the controller 10 through connection plugs 59, such as a 2-pole 3.5 mm jack, where a button 55 is spring-loaded and has a broad outer interface surface 54. When the button 55 is depressed toward the base 53, the switch 56 is activated. Activation of the switch 56 closes the contacts and completes a circuit within the controller 10. While the switch is its open and un-depressed position, the person P moves his head H into contact with the outer surface 54 of the button 55 and biases or pushes the button 55 into contact with the switch 56 to close the circuit.

The controller 10 includes a housing 20 that contains a microprocessor 12 mounted on a PC board 13 and an integral display 30. One or more ports 17 accept the one or more plugs 59, placing the selector device 50 into the circuit communication with a microprocessor 12. The electronic components of the device 10, including the microprocessor 12 and the display 30, are supplied with DC current power supplied by a battery 15 or by a mains alternating current (AC) via outlet plug and cord 16 through a transformer 14. The battery 15 can be a rechargeable lithium ion battery mounted on the inside using Velcro® 115. The microprocessor 12 includes programming for executing an algorithm that converts an electronic signal 90 from the push-button device 51, into an indication signal 92. The indication signal 92 is emitted by the microprocessor 12 over a line 112 to a display 30, which converts the indication signal 92 into a resulting message that can be observed and understood by a third party.

The controller 10 also includes a data port 19, illustrated as a USB port, f©r programming the microprocessor 12.

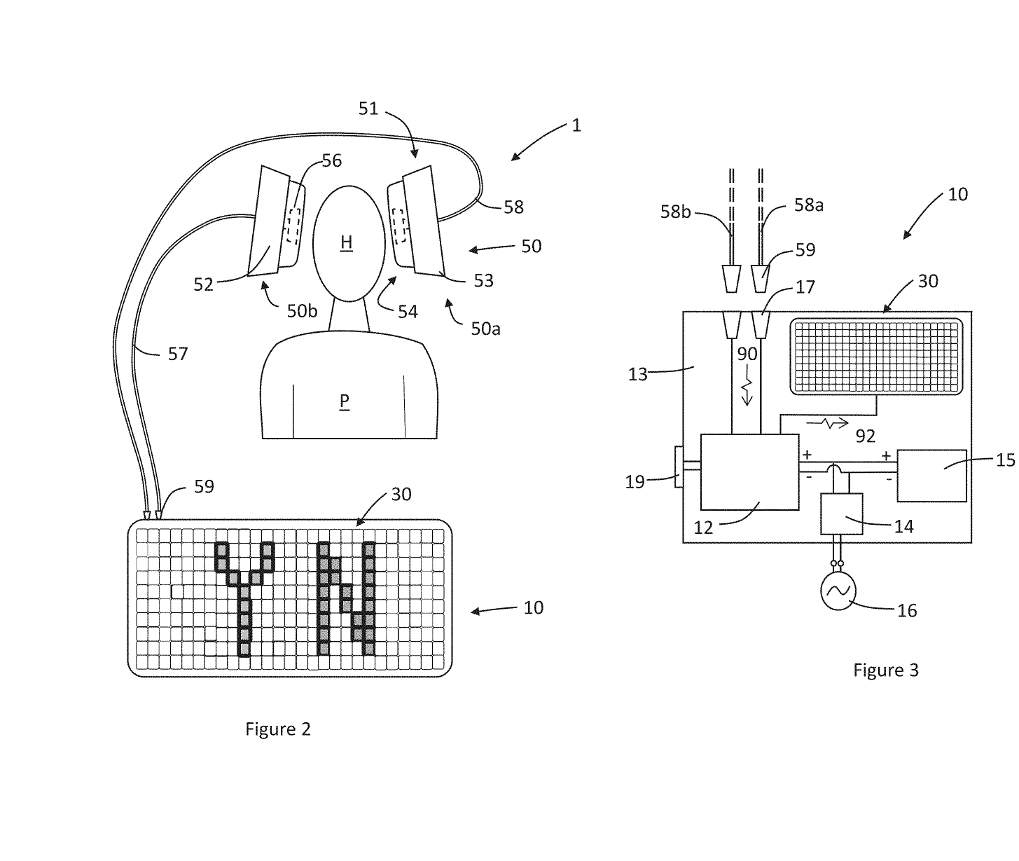

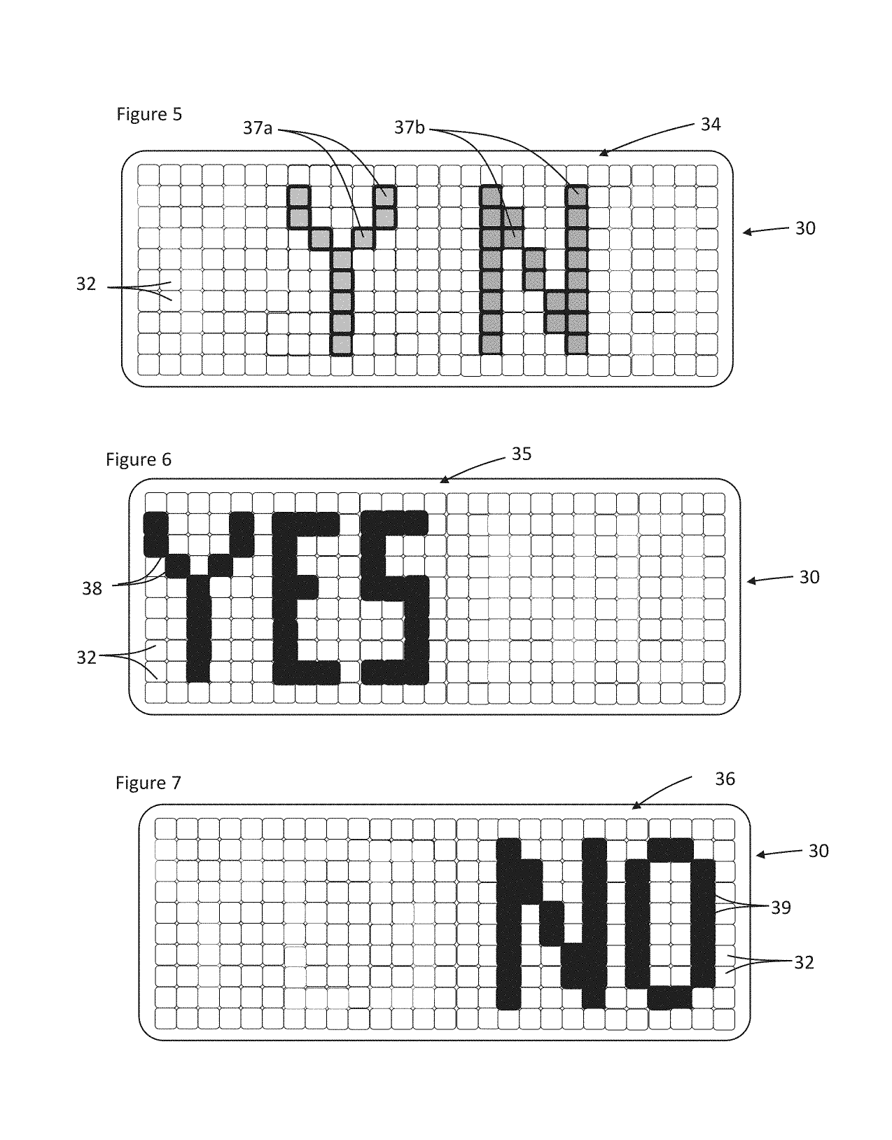

In an embodiment of the invention, as shown in FIG. 5, the display 30 that includes a plurality of light elements 32, and the display 30 displays a pattern of illumination 34 in a ready state. The ready state represents the state when the selector devices are not activated by the person P. The pattern of illumination 34 includes at least a portion of the plurality of light elements 32 illuminated to provide the pattern of illumination 34. In the illustrated embodiment, the pattern of illumination 34 in the ready state includes a “Y” text character in the left half side of the display 30 formed by a pattern of light elements 37a, and an “N” text character in the right half side of the display 30 formed by a pattern of light elements 37b. The color of the illumination of the “Y” and the “N” can be different or the same colors. The placing of the “Y” text characters on the left half side of the display 30 is an indication or reminder to the person P of which direction to tilt his head H in order to give an appropriate answer, for example “yes”, to a question poised to the person P. Thus, a person P facing the display 30 will understand that a “yes” response can be may by tilting his head. H to his left to activate the switch 56 of selector device 50b (FIG. 2), which results in the microprocessor 12 transmitting an indication signal 92 in a pattern of illumination 35 as shown in FIG. 6 for a first response state indicating a “YES” text formed by a pattern of light elements 38. Conversely, the person P will understand that a “no” response can be may by tilting his head H to his right to activate the switch 56 of selector device 50a, which results in transmitting a pattern of illumination 36 as shown in FIG. 7 for a second response state indicating a “NO” text formed by a pattern of light elements 39.

The light elements 38 and 39 can be different colors, or the same color.

FIG. 7 shows the display of FIG. 5 with pattern of illumination in a second response state.

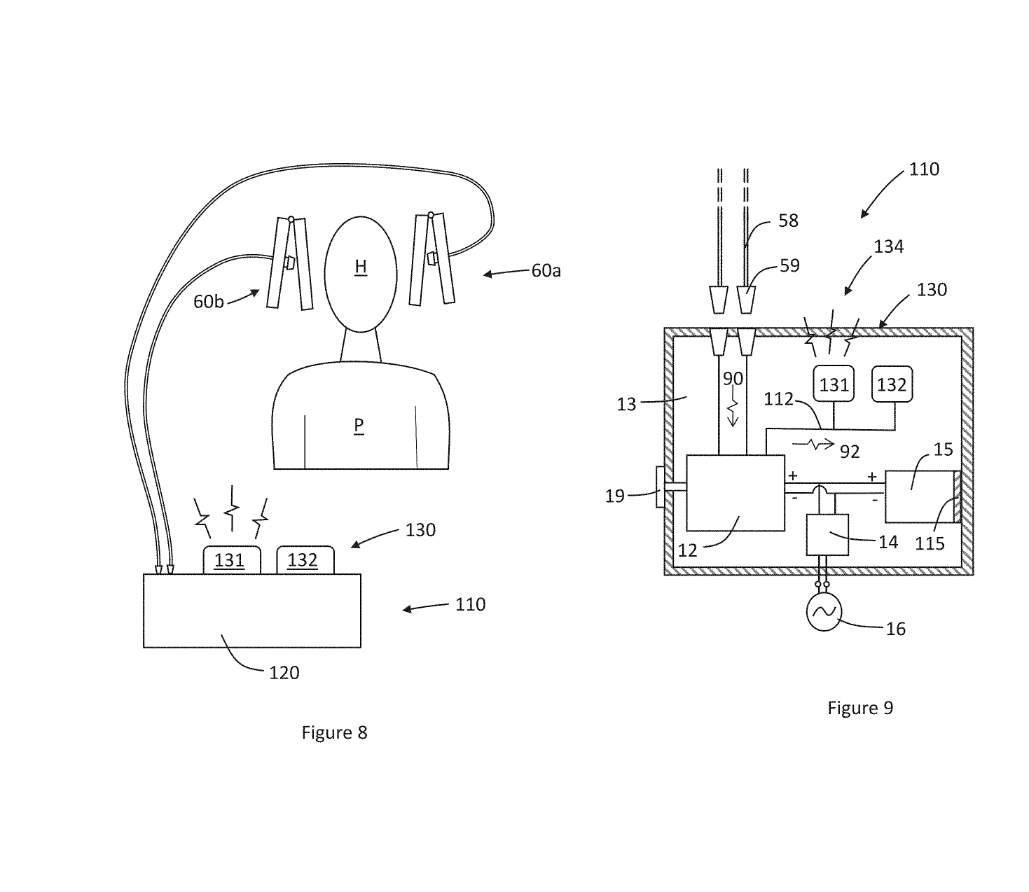

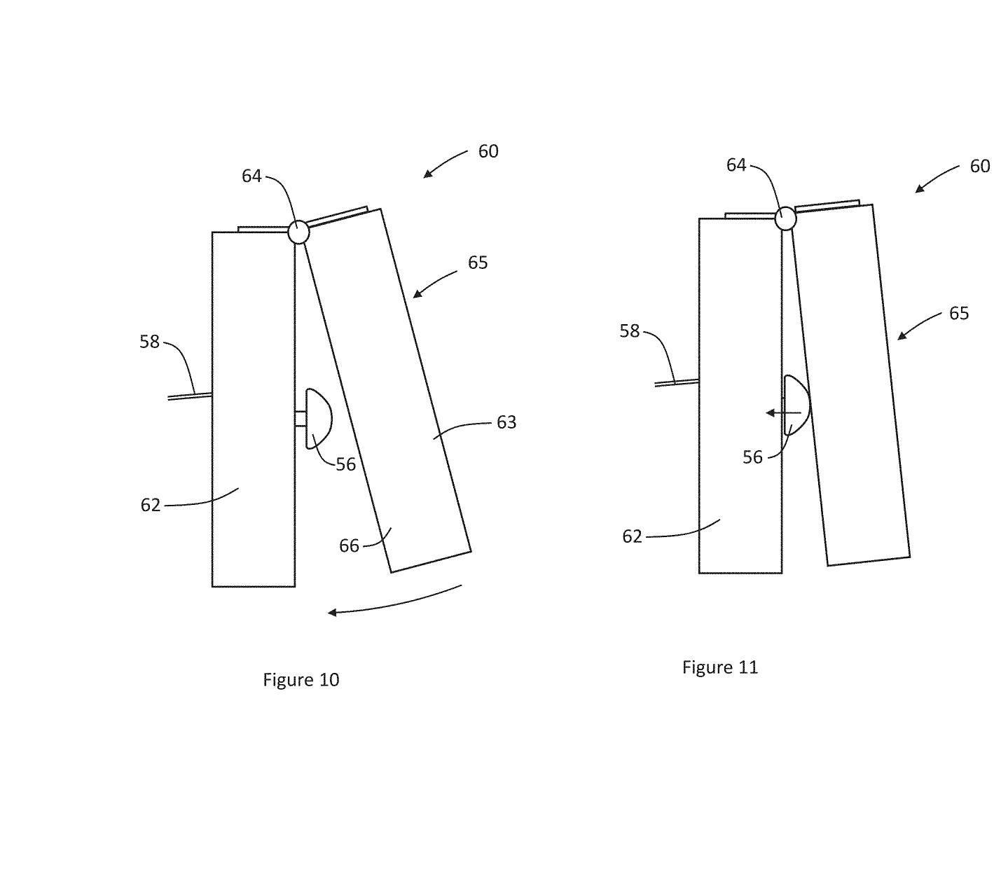

Another embodiment of the invention is shown in FIGS. 8-11, showing an alternative embodiment of selector devices 60, and an alternative embodiment of an indicator device 130. The selector device 60 is illustrated in FIG. 10 as a moveable member 63 hinged at a joint 64 to a base member 62 with a switch 56 between the base and moveable members for activation of the switch 56 when the moveable member 63 is biased toward the base member 62. The moveable member 63 has an outer interface surface 65 against which the person P moves his head H for actuating the switch 56, as shown in FIG. 11.

The indicator device 130 includes a first lamp 131 and a second lamp 132 to indicate either the first response state or the second response state. Illumination 134 of the first lamp 131 can indicate a “yes” response, or first option for a response, such as “left”. Conversely, illumination of the second lamp 132 can indicate a “no” response, or second (or opposite) option for a response, such as “right”. The color of the illumination of the lamps 131 and 132 can be different or the same colors.

I claim:

1. A system for enabling a person with very limited motor and verbal skills to communicate with another person, the system including
a) a mechanical selector device including a switch and having a contact surface configured to actuate the switch when person selectively moves to engage the contact surface, and configured to communicate an electronic contact signal in response to actuation of the switch;
b) a controller unit configured to convert the electronic contact signal into an indication signal, and
c) an indicator device that receives the indication signal and emits a resulting message in response to the selected movement of the person's body.

2. The system according to claim 1, where the mechanical selector device is a first spring-loaded button and a second spring-loaded button, which can be placed on either side of the head of the person.

3. The system according to claim 1, where the mechanical selector device includes a moveable element comprising a spring-biased button and the contact surface is an outer surface of the button.

4. The system according to claim 1, where the switch is an electromechanical switch comprising a push-to-make switch, or a push-to-break switch.

5. The system according to claim 1, where the electronic contact signal is a wired signal or a wireless signal.

6. The system according to claim 1, where the microprocessor includes memory and programming for executing an algorithm that converts the received electronic contact signal to the indication signal.

7. The system according to claim 1, where the indicator device includes a light-emitting device that can include a lamp or a display panel.

8. The system according to claim 1, where a display panel comprising a matrix of a plurality of light emitting diodes (LEDs).

9. The system according to claim 8, where the plurality of LEDs emit light having the different illumination wavelengths for emitting a variety of colored light.

10. The system according to claim 8, where the microprocessor and display panel are configured to emit a resulting message that can include an icon or a message.

11. The system according to claim 10, where the message is a text image.

12. The system according to claim 2, where the microprocessor includes memory and programming for executing an algorithm that either converts a received electronic contact signal from the first spring-loaded button into a first indication signal, or converts the received electronic contact signal from the second spring-loaded button into a second indication signal.

13. The system according to claim 12, where the indicator device includes a light-emitting device that can include a first lamp and a second lamp, or a display panel comprising a matrix of a plurality of light emitting diodes (LEDs).

14. The system according to claim 13, where the plurality of LEDs emit light having the different illumination wavelengths for emitting a variety of colored l response to either the first indication signal or the second indication signal.

15. The system according to claim 14, where the response to the first indication signal or the second indication signal is an icon or a message.

16. The system according to claim 15, where the message is a first text image in response to the first indication signal, and a second text image in response to the second indication signal.
